(19) United States
(12) Patent Application Publication
(10) Pub. No.: US 2008/0121205 A1
(43) Pub. Date: May 29, 2008

(54) Piston For A Combustion Engine

(75) Inventor: Rainer Scharp, Vaihingen (DE)

Correspondence Address: COLLARD & ROE, P.C., 1077 NORTHERN BOULEVARD, ROSLYN, NY, 11576, US

(73) Assignee: MAHLE INTERNATIONAL GMBH, Stuttgart (DE)

(21) Appl. No.: 11/791,806

(22) PCT Filed: Nov. 28, 2005
(86) PCT No.: PCT/DE05/02141

§ 371 Date: Jul. 10, 2007

(30) Foreign Application Priority Data
Nov. 30, 2004 (DE) 10 2004 057 558.4

(51) Int. Cl. F02F 3/26

(52) U.S. Cl. 123/193.6; 123/41.39; 123/305

(57) ABSTRACT

Disclosed is a piston (1) for a combustion engine comprising a closed ring element (6) which is disposed in the radially outer peripheral area of the piston head (5) and is joined to the basic piston member (4) by means of a high-temperature resistant adhesive. The basic member (4) is made of forged aluminum while the ring element (6) is made of Ni-resist. A closed, annular cooling duct (15) that comprises holes for delivering and discharging cooling oil is placed between the basic member (4) and the ring element (6), resulting in a piston (1) that has a simple design, can be produced at low cost, and can be subjected to great thermal loads.

The invention relates to a piston for an internal combustion engine, in accordance with the preamble of the claim.

A piston for an internal combustion engine is known from the Offenlegungsschrift DE 37 14 400 A1, in the edge region of which piston, on the piston crown side, a ring element is disposed, which is connected with the base body of the piston by means of an adhesive resistant to high temperatures, and the purpose of which element consists in fixing a ring insert made of ceramic and disposed on the pin boss side relative to it in place. In this connection, a ceramic material is selected for the purpose of utilizing the thermal insulation effect inherent to this material, and of reducing the temperature-related expansion of the ring insert, which stands in contact with the ring element, which is subject to very great thermal stress, and thereby itself is exposed to very great thermal stress. However, this method of avoiding temperature-related damage to the piston on the basis of overly great thermal stress of individual piston parts is very complicated, and brings with it the disadvantage of significantly increasing the cost of production of the piston.

Proceeding from this, it is the task of the invention to create a piston that has a simple structure, can be produced in price-advantageous manner, and is able to withstand great thermal stress.

This task is accomplished with the characteristics standing in the characterizing part of the main claim.

In particular, the cooling channel that can be introduced between the piston base body and the ring element, in simple manner, assures good cooling both of the ring belt and of the edge of the combustion bowl, which is subject to very great thermal stress, and therefore assures great ability of the piston according to the invention to withstand stress.

An exemplary embodiment of the invention will be described below, using the drawings. These show:

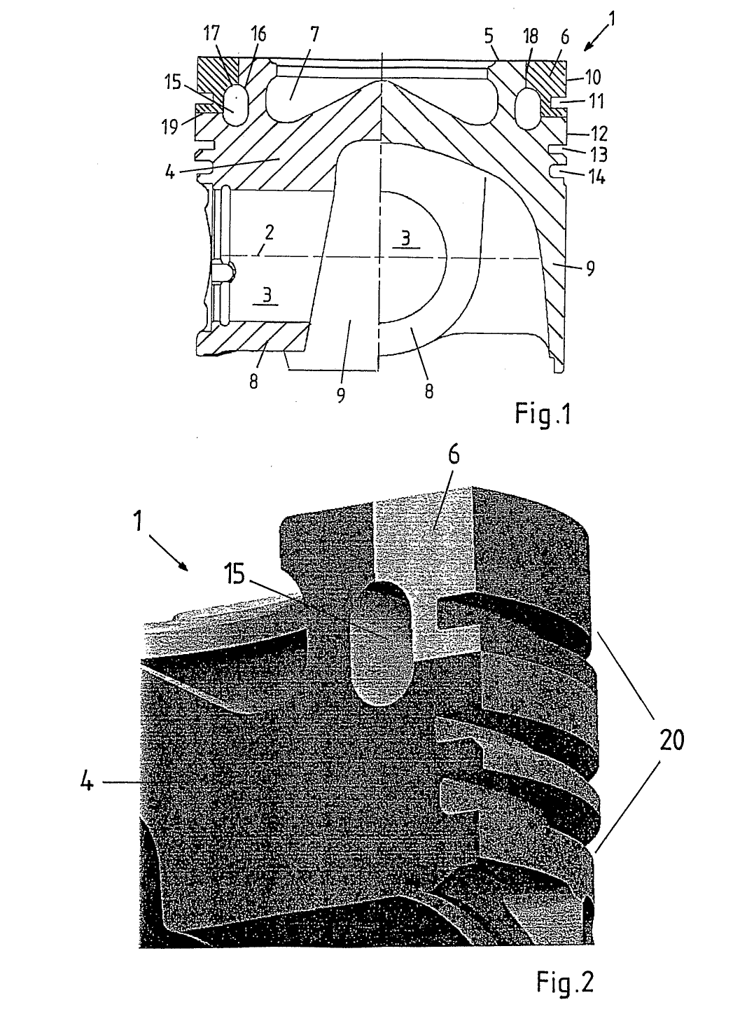

FIG. 1 a piston for an internal combustion engine having a ring element, according to the invention, in a sectional diagram consisting of two halves, which shows two longitudinal sections of the piston, offset by 90°, and

FIG. 2 an enlarged representation of the section through the edge region of the piston crown with the ring element.

FIG. 1 shows a piston 1 for an internal combustion engine in a sectional diagram consisting of two halves, the left half of which shows a section of the piston 1 along a longitudinal axis 2 of a pin bore 3, and the right half of which shows a section through the piston 1 offset by 90° to the left half.

The piston 1 consists of an essentially cylinder-shaped base body 4, the one face of which forms the piston crown 5. A closed ring element 6 is disposed in the radially outer region of the piston crown 5. A combustion bowl 7 is formed into the central region of the piston crown 5, the edge of which bowl is disposed at a distance from the ring element 6, in the radially inner region of the piston crown 5. Furthermore, the base body 4 has pin bosses 8 for the pin bores 3 and skirt elements 9 that connect the pin bosses 8 with one another on its underside, which faces away from the piston crown 5. The ring element 6 has a ring groove 11 on its mantle surface 10 that lies radially on the outside, for a compression ring not shown in the figure. Below this, a second ring groove 13 is disposed in the mantle surface 12 of the base body 4, followed by an oil ring groove 14 on the pin boss side.

A ring-shaped, closed cooling channel 15 is disposed between the ring element 6 and the region of the base body 4 on the piston crown side, which channel is formed partly by a recess 16 formed into the base body 4 and partly by a recess 17 formed into the ring element 6. Cooling oil is guided into the channel 15 and out of it again by way of oil inflow openings and oil outflow openings, not shown in the figures.

The base body 4 is produced from aluminum, whereby first, a blank is produced using the forging method, which is given its final shape by means of a cutting production method (lathing, milling).

The ring element 6 is produced using a casting method, from Niresist, whereby also, a blank is first produced, which is given the shape shown in FIG. 1 by means of a cutting production method. Niresist is an austenitic cast iron that has nickel, manganese, copper, and chrome mixed into it as alloy components. The ring element 6 is connected with the base body 4 by means of an adhesive resistant to high temperatures, by way of the contact regions 18 and 19 between base body 4 and ring element 6.

FIG. 2, in an enlarged representation, shows the edge region of the piston 1 with the ring element 6, with the cooling channel 15 formed by the ring element 6 and the base body 4, and the ring belt 20 disposed partly in the ring element 6 and partly in the base body 4.

### REFERENCE SYMBOL LIST

1 piston
2 longitudinal axis
3 pin bore
4 base body
5 piston crown
6 ring element
7 combustion bowl
8 pin boss
9 skirt element
10 mantle surface of the ring element 6
11 ring groove, compression ring groove
12 mantle surface of the base body 4
13 second ring groove
14 oil ring groove
15 cooling channel
16 recess
17 recess
18 contact region
19 contact region
20 ring belt

1. Piston (1) for an internal combustion engine,
having a base body (4) having a piston crown (5),
having pin bosses (8) disposed on the side of the base body (4) that faces away from the piston crown, and skirt elements (9) that connect the pin bosses (8) with one another,
having a closed ring element (6) disposed in the radially outer region of the piston crown (5), which is connected with the base body (4) by means of an adhesive resistant to high temperatures,
wherein
the base body (4) consists of forged aluminum,
that the ring element (6) consists of Niresist,
that a closed, ring-shaped cooling channel (15) having openings for passing cooling oil in and out is disposed between base body (4) and ring element (6),
that a combustion bowl (7) is formed into the piston crown (5), the edge of which bowl is disposed at a distance from the ring element (6), in the radially inner region of the piston crown (5).
